(19) United States
(12) Patent Application Publication
(10) Pub. No.: US 2017/0123567 A1
(43) Pub. Date: May 4, 2017

(54) DETECTION DEVICE

(71) Applicant: PANASONIC INTELLECTUAL PROPERTY MANAGEMENT CO., LTD., Osaka (JP)

(72) Inventors: Takashi KITADA, Osaka (JP); Naoki KOSUGI, Kyoto (JP); Utaro MIYAGAWA, Kyoto (JP)

(21) Appl. No.: 15/296,699

(22) Filed: Oct. 18, 2016

(30) Foreign Application Priority Data
Oct. 30, 2015 (JP) 2015-213989
Nov. 19, 2015 (JP) 2015-226170
Aug. 23, 2016 (JP) 2016-162347

(51) Int. Cl. G06F 3/041; G06F 3/033; G06F 3/044

(52) U.S. Cl. CPC G06F 3/0416; G06F 3/0412; G06F 3/044; G06F 3/0334

(57) ABSTRACT

A detection device includes a plurality of transmitter electrodes that are provided in a predetermined area, a plurality of receiver electrodes that are provided in the predetermined area and that each intersect with the plurality of transmitter electrodes, a transmitter that is connected to the plurality of transmitter electrodes, a receiver that is connected to the plurality of receiver electrodes, detection electrodes that are provided outside the predetermined area and that are connected to at least one of the transmitter and the receiver, and an operation detector configured to detect an operation of a user based on a reception result of the receiver.

### BACKGROUND

1. Technical Field

The present disclosure relates to a detection device.

2. Description of the Related Art

Unexamined Japanese Patent Publication No. 2003-22158 discloses a system that links a user and a touch position touched by the user. The system includes a surface where a plurality of antennas are disposed. Each antenna transmits a signal that can be uniquely identified. The system receives the identifiable signal via the user.

### SUMMARY

A detection device of the present disclosure includes a plurality of transmitter electrodes that are provided in a predetermined area, a plurality of receiver electrodes that are provided in the predetermined area and that each intersect with the plurality of transmitter electrodes, a transmitter that is connected to the plurality of transmitter electrodes, a receiver that is connected to the plurality of receiver electrodes, a detection electrode that is provided outside the predetermined area and that is connected to at least one of the transmitter and the receiver, and an operation detector configured to detect an operation of a user based on a reception result of the receiver.

According to a user detection device of the present disclosure, an operation of a user may be detected by a simple configuration.

### BRIEF DESCRIPTION OF THE DRAWINGS

FIG. 1 is an external view of a user detection system according to a first exemplary embodiment;

FIG. 2 is a block diagram of a user detection device according to the first exemplary embodiment;

FIG. 3 is a detailed block diagram of the user detection device according to the first exemplary embodiment;

FIG. 4 is a diagram showing a relationship between a position of a user and a touch operation according to the first exemplary embodiment;

FIG. 5 is an operation timing diagram of the user detection device according to the first exemplary embodiment;

FIG. 6 is an image diagram of received data of the user detection device according to the first exemplary embodiment;

FIG. 7 is a diagram showing a relationship between a position of a user and a touch operation according to the first exemplary embodiment;

FIG. 8 is an image diagram of received data of the user detection device according to the first exemplary embodiment;

FIG. 9 is a diagram showing a configuration of a user detection device according to a second exemplary embodiment, and a relationship between a position of a user and a touch operation;

FIG. 10 is an operation timing diagram of the user detection device according to the second exemplary embodiment;

FIG. 11 is an image diagram of received data of the user detection device according to the second exemplary embodiment;

FIG. 12 is a diagram showing a configuration of a user detection device according to a third exemplary embodiment, and a relationship between a position of a user and a touch operation;

FIG. 13 is an operation timing diagram of the user detection device according to the third exemplary embodiment;

FIG. 14 is an image diagram of received data of the user detection device according to the third exemplary embodiment;

FIG. 15 is an external view of a user detection system according to a fourth exemplary embodiment;

FIG. 16 is a diagram showing a configuration of a user detection device according to the fourth exemplary embodiment, and a relationship between a position of a user and a touch operation;

FIG. 17 is an explanatory diagram showing a configuration of a user detection device according to a fifth exemplary embodiment, and a relationship between a position of a user and a touch operation;

FIG. 18 is an operation timing diagram of the user detection device according to the fifth exemplary embodiment;

FIG. 19 is an image diagram of received data of the user detection device according to the fifth exemplary embodiment;

FIG. 20 is a diagram showing a configuration of a user detection device according to a sixth exemplary embodiment, and a relationship between a position of a user and a touch operation;

FIG. 21 is a block diagram of a touch pen according to the sixth exemplary embodiment;

FIG. 22 is an operation timing diagram of the user detection device according to the sixth exemplary embodiment;

FIG. 23 is an image diagram of received data of the user detection device according to the sixth exemplary embodiment; and

FIG. 24 is a perspective view of an external appearance of a user detection device according to the exemplary embodiments of the present disclosure.

### DETAILED DESCRIPTION

In the following, exemplary embodiments will be described in detail with reference to the drawings as appropriate. However, excessively detailed explanation may be omitted. For example, description concerning details of matters already well known, or repeated description for substantially identical configurations may be omitted. These omissions are made for avoiding redundancy in the following description, and for helping those skilled in the art easily understand the description.

Moreover, the accompanying drawings and the following description are provided only for the purpose of helping those skilled in the art sufficiently understand the present disclosure, and therefore are not intended to limit the subject matters of the appended claims in any way.

### First Exemplary Embodiment

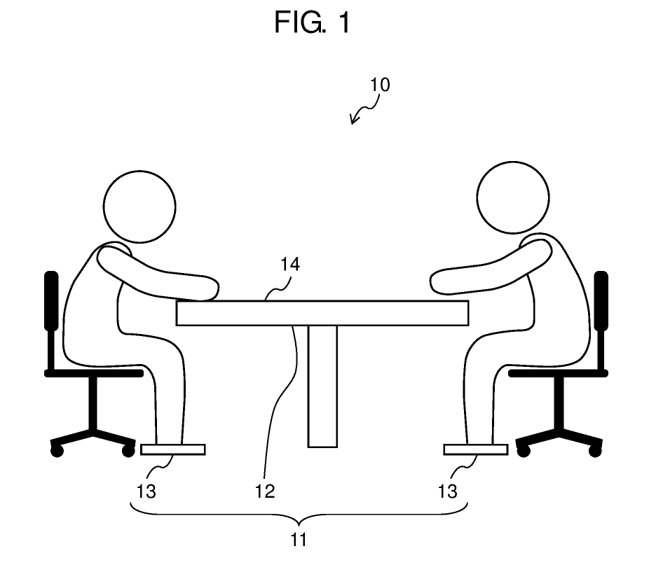

In the following, a first exemplary embodiment will be described with reference to FIGS. 1 to 8. In the first exemplary embodiment, description is given citing a user detection device as a detection device.

### <1-1. Outline>

A user detection device of the first exemplary embodiment uses a touch panel. For example, in a case where user A and user B each touch the touch panel, the user detection device detects positions on the touch panel touched by the users and respective positions of user A and user B in an associated manner. In the following, a position on the touch panel touched by a user will be referred to as a touch position. Also, a position of a user will be referred to as a user position. The user positions of user A and user B are detected by using a part of a system for detecting touch positions.

That is, the user detection device of the first exemplary embodiment is capable of calculating information about operations by user A and user B (touch positions and user positions) by using a simple configuration of a touch panel.

### <1-2. Configuration>

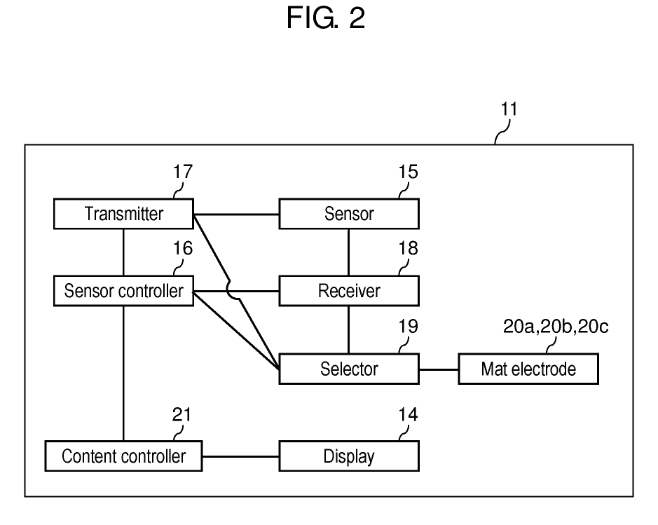

Configurations of user detection system 10 and user detection device 11 will be described with reference to FIGS. 1 and 2. FIG. 1 is an external view of user detection system 10 that uses user detection device 11 according to the first exemplary embodiment. FIG. 2 is a block diagram showing a configuration of user detection device 11 according to the first exemplary embodiment.

As shown in FIG. 1, user detection system 10 uses table 12, and a plurality of mats 13. User detection device 11 is built into table 12 and mats 13.

Display 14 is disposed on an upper surface of table 12. A touch panel is embedded in display 14. Contents, such as images, videos and texts, are to be displayed on display 14.

Mats 13 are each disposed on the ground (floor). Mat 13 is provided for each user. That is, mat 13 is provided at every position where a user is to sit.

User A and user B each sit in a chair. User A touches display 14 with feet placed on mat 13, and operates a content displayed on display 14. In the same manner, user B touches display 14 with feet placed on mat 13, and operates the content displayed on display 14. A plurality of users may simultaneously touch display 14 and perform operation.

Additionally, in the first exemplary embodiment, user A and user B are seated while touching display 14, but the users may perform touch while standing.

As shown in FIG. 2, user detection device 11 of the first exemplary embodiment includes display 14, sensor 15, sensor controller 16, transmitter 17, receiver 18, selector 19, mat electrodes 20a to 20c, and content controller 21.

As described above, display 14 is disposed on the upper surface of table 12 in FIG. 1. Protection glass is disposed on an upper surface of display 14. Display 14 displays a content, such as an image, a video or a text, based on information transmitted from content controller 21.

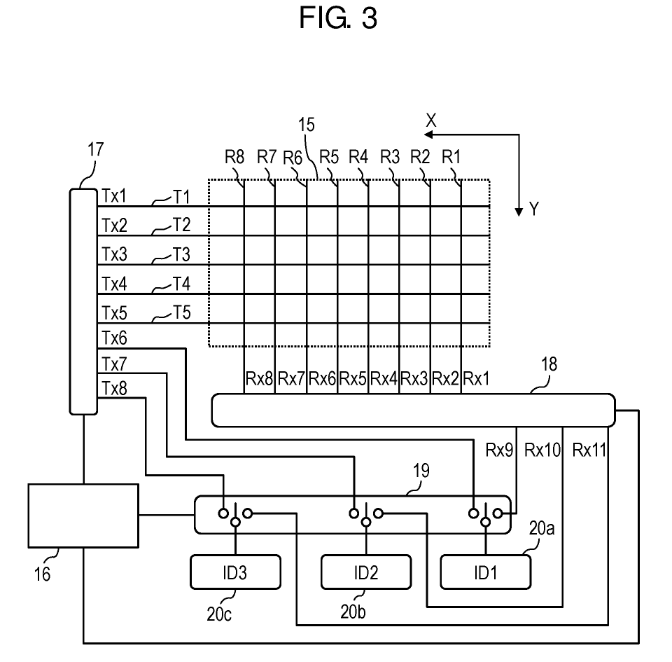

Sensor 15 is an electrode unit where a plurality of transmitter electrodes (transmitter electrodes T1 to T5 shown in FIG. 3) and a plurality of receiver electrodes (receiver electrodes R1 to R8 shown in FIG. 3) described later intersect with one another. Sensor 15 is disposed on the upper surface of display 14. Sensor 15 forms the touch panel integrally with the protection glass described above.

Sensor controller 16 detects an operation by a user based on received data from receiver 18. Then, sensor controller 16 calculates information (a touch position and a user position) about the operation of the user, and transmits the information to content controller 21 described later. Also, sensor controller 16 issues an instruction to selector 19 so as to switch a connection target of mat electrode 20a to 20c to one of transmitter 17 and receiver 18.

According to the instruction from sensor controller 16, transmitter 17 transmits signals of a predetermined pattern, such as a pulse wave or a sine wave, to transmitter electrode T1 to T5 of sensor 15.

Receiver 18 receives a signal from receiver electrode R1 to R8 of sensor 15, and transmits the signal to sensor controller 16.

According to the instruction from sensor controller 16, selector 19 switches the connection target of mat electrode 20a to 20c to one of transmitter 17 and receiver 18.

Mat electrodes 20a to 20c are detection electrodes provided to mats 13. Mat electrodes 20a to 20c are provided one to each mat 13. Ground is provided to mat 13. A predetermined capacitance is formed between the ground and each mat electrode 20a to 20c. A size of mat electrode 20a to 20c may be freely set according to the use environment. To specify a user by using mat electrode 20a to 20c, the size of mat electrode 20a-20c is desirably a size allowing only one user to touch. For example, desirably each mat electrode 20a to 20c is about 50 cm in height and about 50 cm in width.

Content controller 21 is a controller that performs control in an overall manner. Content controller 21 determines a content to be displayed based on the information from sensor controller 16. Then, content controller 21 transmits, to display 14, information about the content to be displayed. A user is thereby allowed to perform a touch operation on the content that is displayed on display 14. Specifically, the position of the content may be changed, or the content may be enlarged or reduced, or another content may be acquired.

Additionally, content controller 21 may be provided inside table 12, or outside table 12. Also, content controller 21 may be a personal computer or a general-purpose terminal such as a mobile terminal.

Detailed configurations mainly of sensor 15 and mat electrodes 20a to 20c will be described with reference to FIG. 3. FIG. 3 is a detailed block diagram of user detection device 11 according to the first exemplary embodiment.

Transmitter 17 includes output terminals of output Tx1 to output Tx8.

Receiver 18 includes input terminals of input Rx1 to input Rx11.

As described above, sensor 15 includes transmitter electrodes T1 to T5, and receiver electrodes R1 to R8. Transmitter electrodes T1 to T5 and receiver electrodes R1 to R8 are formed in a lattice shape, and intersect with one another. In the first exemplary embodiment, transmitter electrodes T1 to T5 and receiver electrodes R1 to R8 are orthogonal to one another.

Transmitter electrodes T1 to T5 are connected to outputs Tx1 to Tx5 of transmitter 17 in a one-to-one manner.

Receiver electrodes R1 to R8 are connected to inputs Rx1 to Rx8 of receiver 18 in a one-to-one manner.

A number of mat electrodes 20a to 20c is plural. The number of mat electrodes 20a to 20c is arbitrary, but in FIG. 3, three mat electrodes 20a to 20c are provided.

Each mat electrode 20a to 20c is connected to transmitter 17 and receiver 18 via selector 19. Specifically, mat electrode 20a is connected to output Tx6 of transmitter 17 and input Rx9 of receiver 18 via selector 19. Mat electrode 20b is connected to output Tx7 of transmitter 17 and input Rx10 of receiver 18 via selector 19. Mat electrode 20c is connected to output Tx8 of transmitter 17 and input Rx11 of receiver 18 via selector 19. Additionally, mat electrode 20a to 20c is electrically connected to one of transmitter 17 and receiver 18 by a switch of selector 19.

Furthermore, ID1, which is identification information, is associated with mat electrode 20a. In the same manner, identification information ID2 is associated with mat electrode 20b, and identification information ID3 with mat electrode 20c.

Additionally, outputs Tx6 to Tx8 of transmitter 17 desirably have a same structure as outputs Tx1 to Tx5. Also, inputs Rx9 to Rx11 of receiver 18 desirably have a same structure as inputs Rx1 to Rx8. This allows some of input/output terminals provided to transmitter 17 and receiver 18 to connect to sensor 15, and other input/output terminals to connect to mat electrodes 20a to 20c. Versatility of user detection device 11 is thereby enhanced. However, it is also possible to provide outputs Tx6 to Tx8 and inputs Rx9 to Rx11 separately for mat electrodes 20a to 20c. Also in the case of separate provision, received data to be received via sensor 15 and mat electrodes 20a to 20c is determined by sensor controller 16.

### <1.3 Operation>

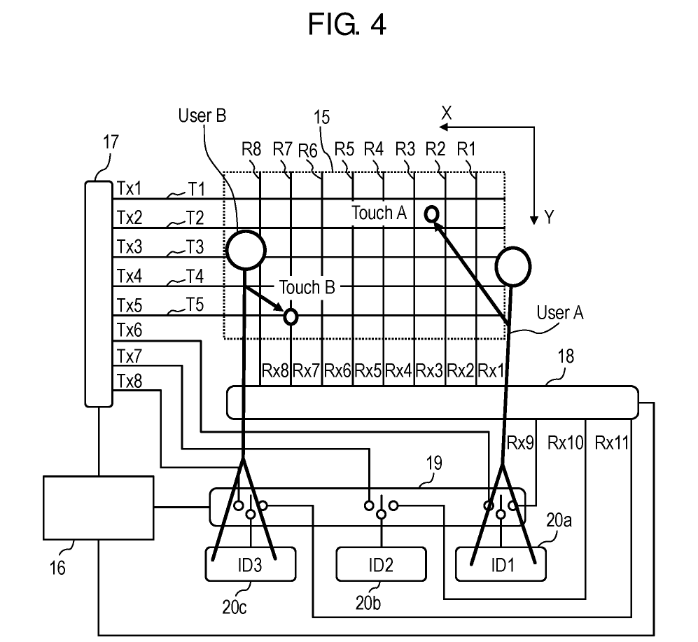

Operation of user detection device 11 configured in the above manner will be described with reference to FIGS. 4 to 8.

FIG. 4 is a diagram showing a relationship between positions of two users (user A and user B) and touch operations according to the first exemplary embodiment. In FIG. 4, user detection device 11, and user A and user B are schematically shown. Additionally, a number of users is two in the first exemplary embodiment, but any number is allowed.

In the first exemplary embodiment, a direction, of sensor 15, parallel to transmitter electrodes T1 to T5 is given as an X-axis direction, and a direction parallel to receiver electrodes R1 to R8 is given as a Y-axis direction.

User A is present on mat electrode 20a (ID1). User A is touching a position within an area of sensor 15. The position being touched is given as touch A. The position of touch A on sensor 15 along the X-axis direction is around a middle of receiver electrode R2 connected to input Rx2 and receiver electrode R3 connected to input Rx3. The position of touch A in the Y-axis direction is around a middle of transmitter electrode T1 connected to output Tx1 and transmitter electrode T2 connected to output Tx2.

Furthermore, user B is present on mat electrode 20c (ID3). User B is also touching a position within the area of sensor 15. The position being touched is given as touch B. A position of touch B along the X-axis direction is on receiver electrode R7 connected to input Rx7. The position of touch B in the Y-axis direction is on transmitter electrode T5 connected to output Tx5.

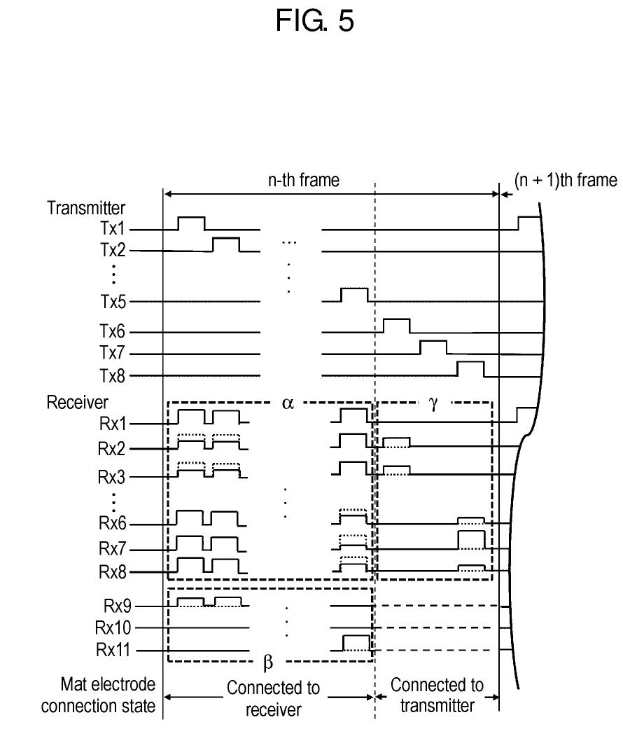

Operation of user detection device 11 when the touch operations described above are performed will be described with reference to FIG. 5. FIG. 5 is an operation timing diagram of user detection device 11 according to the first exemplary embodiment.

As shown in FIG. 5, first, according to an instruction from sensor controller 16, transmitter 17 sequentially outputs predetermined pulse signals starting from output Tx1, in the order of output Tx2, output Tx3, output Tx4, and output Tx5. The timings of output of the signals are different. Accordingly, signals may be uniquely identified on a per-output (output Tx1 to Tx5) basis. To uniquely identify a signal on a per-output basis, each signal output from outputs Tx1 to Tx5 may be made a signal combining a plurality of pulses. If the combination of pulses is made different for each output (output Tx1 to Tx5), signals may be uniquely identified even when timing of output is the same.

During a period when signals are output from outputs Tx1 to Tx5, sensor controller 16 shown in FIG. 4 controls selector 19 so that mat electrodes 20a to 20c and inputs Rx9 to Rx11 of receiver 18 are connected.

Then, when the predetermined pulse signals are output from outputs Tx1 to Tx5, the signals are input, respectively, to transmitter electrodes T1 to T5 shown in FIG. 4. Then, each signal is conveyed from transmitter electrode T1 to T5 to receiver electrode R1 to R8 at each intersection of transmitter electrode T1 to T5 and receiver electrode R1 to R8. When the signals are conveyed to receiver electrodes R1 to R8, received signals corresponding to the predetermined pulse signals are input to inputs Rx1 to Rx8 of receiver 18 as shown in broken-line frame α in FIG. 5.

In broken-line frame α, signal levels of received signals at the time when user A is touching touch A and user B is touching touch B are shown by solid lines. Also, for comparison purposes, signal levels of received signals at the time when user A is not touching touch A and user B is not touching touch B are shown by broken lines. In the following, the signal level of a received signal will be referred to as a reception level.

The reception level changes according to the capacitance between electrodes at each intersection of transmitter electrodes T1 to T5 and receiver electrodes R1 to R8. Accordingly, as shown in broken-line frame α in FIG. 5, the reception level near touch A is reduced when user A is touching touch A compared to when user A is not touching touch A. In the same manner, the reception level near touch B is reduced when user B is touching touch B compared to when user B is not touching touch B.

Here, the rate of reduction in the reception level is greater as touch A and touch B are nearer to an intersection of transmitter electrode T1 to T5 and receiver electrode R1 to R8. That is, when touch A and touch B are compared, touch A is shifted from each of intersections of transmitter electrode T1, transmitter electrode T2 and receiver electrode R2, receiver electrode R3, but touch B is at an intersection of transmitter electrode T5 and receiver electrode R7. Accordingly, input Rx7, which is connected to receiver electrode R7, detects a signal with the greatest reduction rate in broken-line frame α in FIG. 5.

Furthermore, because user A is touching touch A, the predetermined pulse signals supplied from outputs Tx1 and Tx2 to transmitter electrode T1 and transmitter electrode T2, respectively, are detected at input Rx9 through the finger of user A touching touch A, the body of user A, mat electrode 20a, and selector 19. The signal detected at input Rx9 is shown with a solid line at the top left in broken-line frame β in FIG. 5. Additionally, for comparison purposes, a received signal at input Rx9 when user A is not touching touch A is shown with a broken line at the same position in broken-line frame β.

In the same manner, because user B is touching touch B, the predetermined pulse signal output from output Tx5 and supplied to transmitter electrode T5 is detected at input Rx11 through the finger of user B, the body of user B, mat electrode 20c, and selector 19. The signal detected at input Rx11 is shown with a solid line at the bottom right in broken-line frame β. For comparison purposes, a received signal at input Rx11 when user B is not touching touch B is shown with a broken line at the same position in broken-line frame β.

At inputs Rx9 to Rx11, reception levels are greater as touch A and touch B are nearer to transmitter electrodes T1 to T5. That is, when touch A and touch B are compared, the distance to transmitter electrode T1 to T5 is smaller for touch B. Accordingly, input Rx11 receiving a signal from transmitter electrode T5 touched by touch B detects the signal with the highest reception level in broken-line frame β in FIG. 5.

Also, following output Tx5, transmitter 17 sequentially outputs predetermined pulse signals from output Tx6, output Tx7, and output Tx8. In the period, sensor controller 16 controls selector 19 in such a way that mat electrodes 20a-20c are connected to outputs Tx6-Tx8 of transmitter 17, respectively.

Here, the predetermined pulse signal supplied from output Tx6 is transmitted to receiver electrode R2 and receiver electrode R3 through selector 19, mat electrode 20a, the body of user A, and the finger touching touch A. Then, the signal transmitted to each of receiver electrode R2 and receiver electrode R3 is input to input Rx2 and input Rx3 of receiver 18. Input Rx2 and input Rx3 detect signals shown with solid lines at the top left in broken-line frame γ in FIG. 5. Additionally, for comparison purposes, received signals at input Rx2 and input Rx3 when user A is not touching touch A are shown with broken lines at the same position in broken-line frame γ.

In the same manner, the predetermined pulse signal supplied from output Tx8 is transmitted to receiver electrodes R6 to R8 through selector 19, mat electrode 20c, the body of user B, and the finger touching touch B. Then, inputs Rx6 to Rx8 of receiver 18 detect signals shown with solid lines at bottom right in broken-line frame γ in FIG. 5. For comparison purposes, received signals at inputs Rx6 to Rx8 when user B is not touching touch B are shown with broken lines at the same position in broken-line frame γ.

In broken-line frame γ in FIG. 5, the reception levels at inputs Rx1 to Rx8 are higher as touch A and touch B are nearer to receiver electrodes R1 to R8. That is, input Rx7, which is connected to receiver electrode R7 touched by touch B, detects the signal with the highest reception level in broken-line frame γ.

The operation at the timing described above is operation corresponding to one frame, and the operation is repeated. In the following, an arbitrary frame shown in FIG. 5 is taken as an n-th frame.

As described above, in an n-th frame, receiver 18 receives signals at the reception levels shown in broken-line frame α by using signal paths (first signal paths) extending from outputs Tx1 to Tx5 of transmitter 17 to inputs Rx1 to Rx8 of receiver 18 through transmitter electrodes T1 to T5 and receiver electrodes R1 to R8. Then, sensor controller 16 calculates touch positions of user A and user B based on reception results at receiver 18. A touch position may be expressed in xy coordinates (x, y) by specifying positions, on sensor 15, in the X-axis direction and the Y-axis directions. In the following, the xy coordinates showing the touch position will be referred to as touch coordinates. The operation is the same as a regular touch panel of an electrostatic matrix sensor type.

Furthermore, in the n-th frame, receiver 18 receives signals at reception levels shown in broken-line frame β by using signal paths (second signal paths) extending from outputs Tx1 to Tx5 to inputs Rx9 to Rx11 of receiver 18 through transmitter electrodes T1 to T5, the fingers and the bodies of the users performing touch operation, and mat electrodes 20a to 20c. Then, sensor controller 16 calculates IDs corresponding to respective mat electrodes 20a to 20c, and y coordinates of the touch coordinates of user A and user B based on reception results at receiver 18.

Moreover, in the n-th frame, receiver 18 receives signals at reception levels shown in broken-line frame γ by using signal paths (third signal paths) extending from outputs Tx6 to Tx8 to inputs Rx1 to Rx8 through mat electrodes 20a to 20c, the fingers and the bodies of the users performing touch operation, and receiver electrodes R1 to R8. Then, IDs corresponding to mat electrodes 20a to 20c, and x coordinates of the touch coordinates of user A and user B are calculated based on reception results at receiver 18.

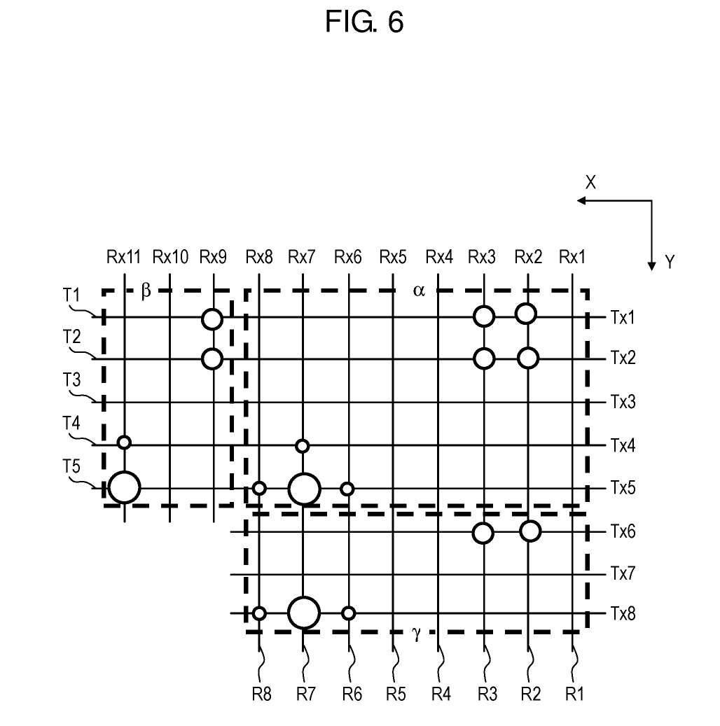

FIG. 6 is an image diagram of received data of user detection device 11 according to the first exemplary embodiment. Association of a touch position (touch coordinates) and a user position will be described with reference to FIG. 6.

FIG. 6 shows an image of received data that is obtained at receiver 18 by a series of operations in the n-th frame. Broken-line frame α, broken-line frame β, broken-line frame γ in FIG. 6 correspond respectively to broken-line frame α, broken-line frame β, broken-line frame γ in FIG. 5. In FIG. 6, the reception level when sensor 15 is touched by neither user A nor user B is taken as a reference state, and a size of a change in the reception level is indicated by a size of a circle. That is, a part where there is no circle is a part where there is no change in the reception level, that is, a part that is touched by neither user A nor user B. A larger circle means that the coordinates are nearer to a touch position. Additionally, because the size of a circle indicates the degree of a change in the reception level, a large circle is shown if either of the reduction rate and the increase rate of a received signal is great, for example.

Sensor controller 16 determines the touch coordinates based on received data shown in broken-line frame α in FIG. 6. In a region at the top right in broken-line frame α, approximately the same change is detected for a plurality of adjacent intersections. Specifically, approximately the same change is detected for the coordinates of each intersection of transmitter electrode T1, transmitter electrode T2 and receiver electrode R2, receiver electrode R3. Accordingly, touch coordinates (x, y) are calculated to be (middle of receiver electrode R2 and receiver electrode R3, middle of transmitter electrode T1 and transmitter electrode T2).

Also, in a region at the bottom left in broken-line frame α, a change is detected for a plurality of adjacent intersections. However, an amount of change at the intersection at the center is sufficiently great compared to amounts of change at the peripheral intersections. Specifically, a greater change is detected for coordinates of intersection of transmitter electrode T5 and receiver electrode R7 than for the peripheral coordinates. Accordingly, the touch coordinates (x, y) are calculated to be (on receiver electrode R7, on transmitter electrode T5). In this manner, two touch coordinates are calculated in broken-line frame α. The calculation method for such touch coordinates is the same as the method of a regular touch panel of an electrostatic sensor type, and may be arbitrarily decided.

Additionally, in the following description, coordinates of transmitter electrode T1 to T5 and receiver electrode R1 to R8 will be expressed by using input Rx or output Tx to which each electrode is connected. Specifically, a position in the middle of receiver electrode R2 and receiver electrode R3 will be expressed as Rx2Rx3, and a position on receiver electrode R7 will be expressed as Rx7. For example, in the example described above, the touch coordinates (x, y) in broken-line frame α in FIG. 6 are (Rx2Rx3, Tx1Tx2) and (Rx7, Tx5).

Furthermore, sensor controller 16 calculates two ID-appended y coordinates (ID, y) based on the received data shown in broken-line frame β in FIG. 6. Specifically, an ID-appended y coordinate (ID, y)=(1, Tx1Tx2) is calculated based on received data of signals transmitted from outputs Tx1 to Tx5 and received by input Rx9 through user A himself/herself and mat electrode 20a (ID1). Also, in the same manner, an ID-appended y coordinate (ID, y)=(3, Tx5) is calculated based on received data of signals output from outputs Tx1 to Tx5 and received by input Rx11 through user B himself/herself and mat electrode 20c (ID3).

Next, sensor controller 16 calculates two ID-appended x coordinates (ID, x) based on the received data shown in broken-line frame γ in FIG. 6. Specifically, an ID-appended x coordinate (ID, x)=(1, Rx2Rx3) is calculated based on received data of a signal transmitted from output Tx6 and received by inputs Rx1 to Rx8 through user A himself/herself and mat electrode 20a (ID1). Also, in the same manner, an ID-appended x coordinate (ID, x)=(3, Rx7) is calculated based on received data of a signal transmitted from output Tx8 and received by inputs Rx1 to Rx8 through user B himself/herself and mat electrode 20c (ID3).

Sensor controller 16 combines the ID-appended y coordinate and the ID-appended x coordinate with the ID as a common term. ID-appended xy coordinates (ID, x, y) are thereby calculated. That is, two sets of ID-appended xy coordinates, (ID, x, y)=(1, Rx2Rx3, Tx1Tx2) and (ID, x, y)=(3, Rx7, Tx5), are calculated.

Then, sensor controller 16 links the ID-appended xy coordinates and touch coordinates with matching xy coordinates. The ID may thereby be linked to the touch coordinates. Specifically, ID-appended touch coordinates (ID, x, y)=(1, Rx2Rx3, Tx1Tx2) and (ID, x, y)=(3, Rx7, Tx5), are calculated.

Accordingly, IDs corresponding to the operation positions of respective users, that is, mat electrodes 20a to 20c, may be linked to a plurality of sets of touch coordinates. Particularly, in a case where each user is associated with mat electrode 20a to 20c, the ID may be used as identification information of each user.

Additionally, the calculated ID-appended touch coordinates are transmitted to content controller 21, and content controller 21 determines a content to be displayed on display 14 based on the ID-appended touch coordinates.

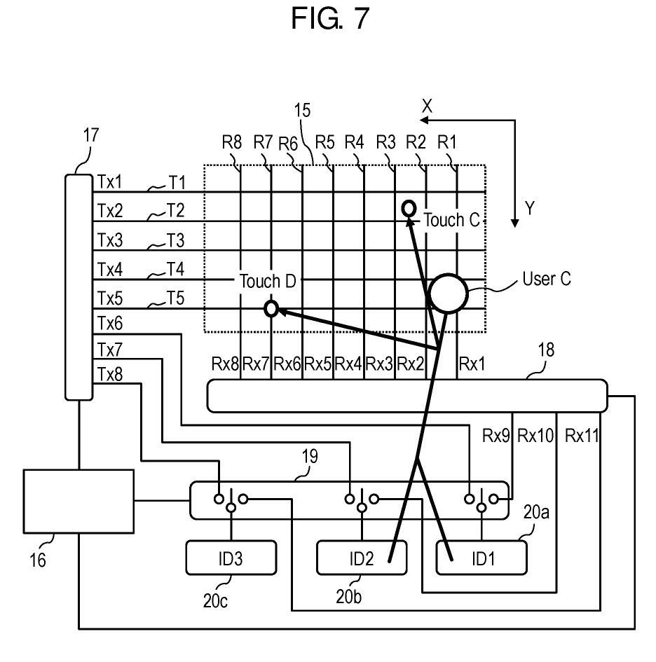

In the following, another operation of user detection device 11 will be described with reference to FIG. 7 for better understanding of the operation of user detection device 11. The operation is operation for a case where user detection device 11 is operated by one user.

As shown in FIG. 7, user C is on both mat electrode 20a (ID1) and mat electrode 20b (ID2). Also, user C is touching positions, on sensor 15, of touch C corresponding to touch A in FIG. 4 and touch D corresponding to touch B in FIG. 4.

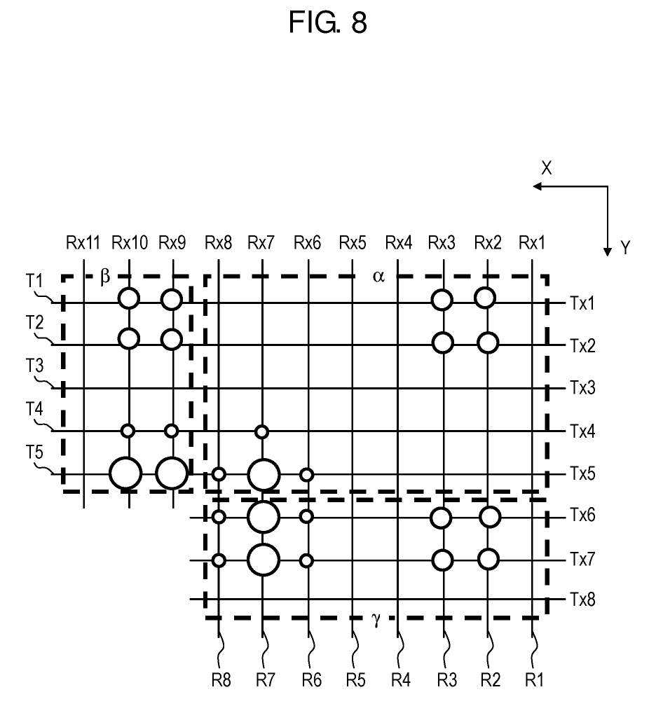

An image of received data of user detection device 11 in the case of a touch operation as described above will be described with reference to FIG. 8.

Sensor controller 16 calculates two touch coordinates (x, y)=(Rx2Rx3, Tx1Tx2) and (x, y)=(Rx7, Tx5) based on received data shown in broken-line frame α in FIG. 8.

At the same time, sensor controller 16 calculates four ID-appended y coordinates (ID, y) based on received data shown in broken-line frame β. Specifically, ID-appended y coordinates (ID, y)=(1, Tx1Tx2) and (ID, y)=(1, Tx5) are calculated based on received data of signals transmitted from outputs Tx1 to Tx5 and received by input Rx9 through user C himself/herself and mat electrode 20a (ID1).

Also, in the same manner, ID-appended y coordinates (ID, y)=(2, Tx1Tx2) and (ID, y)=(2, Tx5) are calculated based on received data of signals transmitted from outputs Tx1 to Tx5 and received by input Rx10 through user C himself/herself and mat electrode 20b (ID2).

Next, sensor controller 16 calculates four ID-appended x coordinates (ID, x) based on received data shown in broken-line frame γ. Specifically, ID-appended x coordinates (ID, x)=(1, Rx2Rx3) and (ID, x)=(1, Rx7) are calculated based on received data of a signal transmitted from output Tx6 and received by inputs Rx1 to Rx8 through user C himself/herself and mat electrode 20a (ID1).

Also, in the same manner, ID-appended x coordinates (ID, x)=(2, Rx2Rx3) and (ID, x)=(2, Rx7) are calculated based on received data of a signal transmitted from output Tx7 and received by inputs Rx1 to Rx8 of receiver 18 through user C himself/herself and mat electrode 20b (ID2).

Sensor controller 16 combines the ID-appended x coordinate and the ID-appended y coordinate calculated in the above manner with the ID as a common term. ID-appended xy coordinates (ID, x, y) are thereby calculated. That is, four sets of ID-appended xy coordinates, (ID, x, y)=(1, Rx2Rx3, Tx1Tx2), (ID, x, y)=(2, Rx2Rx3, Tx1Tx2), (ID, x, y)=(1, Rx7, Tx5), and (ID, x, y)=(2, Rx7, Tx5), are calculated.

In the case of combining an ID-appended x coordinate and an ID-appended y coordinate with an ID as a common term, combinations such as ID-appended xy coordinates (ID, x, y)=(1, Rx2Rx3, Tx5), (ID, x, y)=(1, Rx7, Tx1Tx2) and the like may also be calculated. However, the parts (x, y) of these ID-appended xy coordinates do not exist as the touch coordinates (x, y) that are calculated based on the received data shown in broken-line frame α in FIG. 8. Accordingly, these are not calculated as the ID-appended touch coordinates described later.

Lastly, sensor controller 16 gives an ID to the touch coordinates whose xy coordinates match the xy coordinates of the ID-appended xy coordinates described above, and calculates the ID-appended touch coordinates (ID, x, y). ID1 and ID2 may thereby be linked to the touch coordinates of touch C, and ID-appended touch coordinates (ID, x, y)=(1, Rx2Rx3, Tx1Tx2) and (ID, x, y)=(2, Rx2Rx3, Tx1Tx2) are calculated. ID1 and ID2 may also be linked to the touch coordinates of touch D, and ID-appended touch coordinates (ID, x, y)=(1, Rx7, Tx5) and (ID, x, y)=(2, Rx7, Tx5) are calculated.

It can be judged from the results described above that touch operations at touch C and touch D have each been performed at both mat electrode 20a and mat electrode 20b. That is, it can be judged that one user has performed two touch operations while being on mat electrode 20a and mat electrode 20b.

### <1-3. Effects, etc.>

As described above, according to the first exemplary embodiment, the user detection device enables to detect the operation position of the user, in addition to detect the touch coordinates of a user on the touch panel, by using the configuration of the touch panel. That is, information about an operation of a user (touch coordinates and operation position) may be calculated by a simple configuration. Therefore, a plurality of touch operations may be distinguished from each other. As a result, the user detection device may be used to identify a user or to detect movement of a user, for example.

### Second Exemplary Embodiment

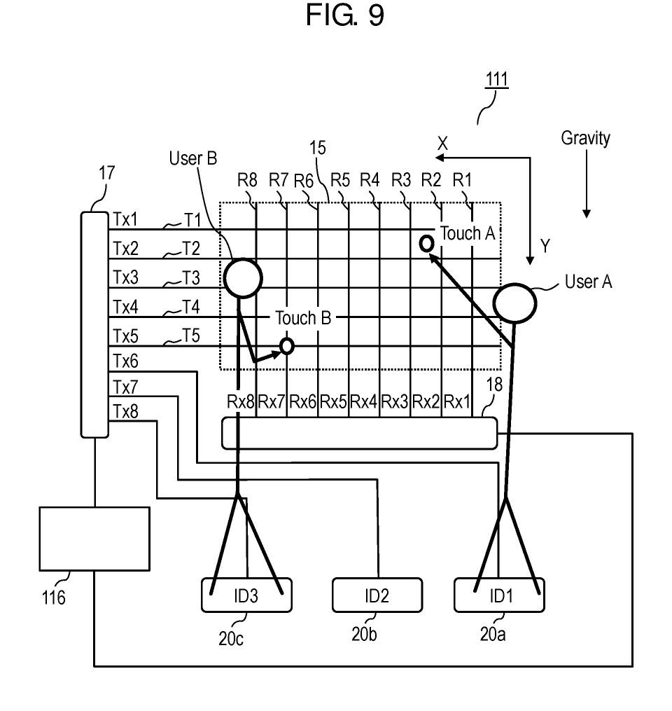

In the following, user detection device 111 of a second exemplary embodiment will be described with reference to FIGS. 9 to 11. While user detection device 11 of the first exemplary embodiment uses table 12, user detection device 111 of the second exemplary embodiment uses a blackboard-type display. A surface, of the display, where sensor 15 is formed (hereinafter referred to as a sensor surface) is parallel to the gravity direction.

According to user detection device 111, display is attached to a wall, hung from the ceiling or placed upright on the floor, for example, so as to make the sensor surface parallel to the gravity direction. The configuration of user detection device 111 according to the second exemplary embodiment is approximately the same as the configuration according to the first exemplary embodiment except that selector 19 shown in FIG. 3 is not provided. Accordingly, detailed description regarding the same configuration, operation, effects and the like as the first exemplary embodiment will be omitted.

In the second exemplary embodiment, a direction, of the sensor surface, parallel to gravity is given as a Y-axis direction, and a direction orthogonal to the Y-axis is given as an X-axis direction.

Each transmitter electrode T1 to T5 is disposed in parallel to the X-axis.

Each receiver electrode R1 to R8 is disposed in parallel to the Y-axis.

### <2-1. Configuration>

FIG. 9 is a diagram showing a configuration of user detection device 111 according to the second exemplary embodiment, and a relationship between a position of a user and a touch operation.

Unlike in the first exemplary embodiment, in the second exemplary embodiment as shown in FIG. 9, mat electrodes 20a to 20c are connected to transmitter 17 without selector 19 in FIG. 3 disposed in between. As in the first exemplary embodiment, mat electrodes 20a to 20c are associated with pieces of identification information ID1-ID3, respectively.

### <2-2. Operation>

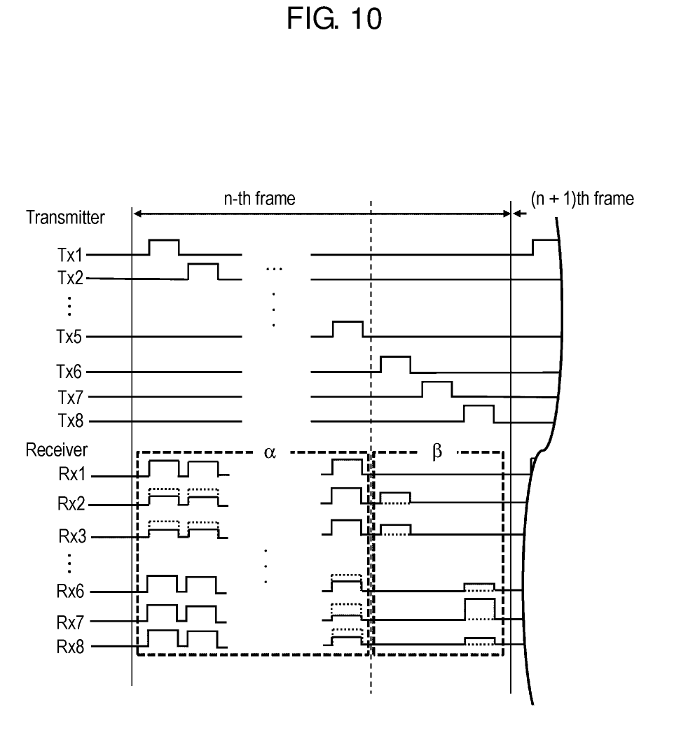

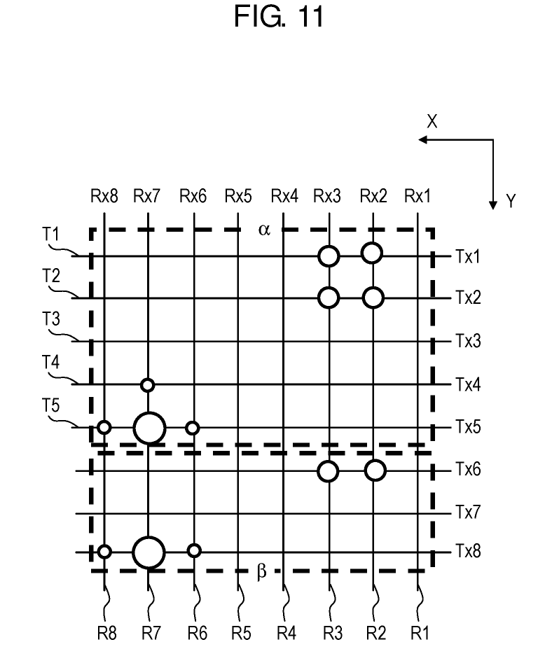

Operation of user detection device 111 will be described with reference to FIGS. 9 to 11. FIG. 10 is an operation timing diagram of user detection device 111 according to the second exemplary embodiment, and FIG. 11 is an image diagram of received data of user detection device 111 according to the second exemplary embodiment.

As shown in FIG. 9, user A is on mat electrode 20a (ID1). User A touches the position of touch A on the sensor surface. The position of touch A in the X-axis direction is around a middle of receiver electrode R2 and receiver electrode R3. The position of touch A in the Y-axis direction is around a middle of transmitter electrode T1 and transmitter electrode T2.

User B is on mat electrode 20c (ID3). User B touches the position of touch B on the sensor surface. The position of touch B in the X-axis direction is on receiver electrode R7. The position of touch B in the Y-axis direction is on transmitter electrode T5.

As shown in FIG. 10, outputs Tx1 to Tx8 output predetermined pulse signals in order from output Tx1.

As shown in broken-line frame α in FIG. 10, received signals according to the pulse signals from outputs Tx1 to Tx5 are input to inputs Rx1 to Rx8.

As shown in broken-line frame β in FIG. 10, the predetermined pulse signal output from output Tx6 is detected at input Rx2 and input Rx3 through mat electrode 20a, user A, and receiver electrode R2 and receiver electrode R3. Also, the predetermined pulse signal output from output Tx8 is detected at inputs Rx6 to Rx8 through mat electrode 20c, user B, and receiver electrodes R6 to R8.

The operations shown in broken-line frame α and broken-line frame β are in one frame, and the operations are repeated several times. An arbitrary frame shown in FIG. 10 is taken as an n-th frame. Additionally, in broken-line frame α, broken-line frame β in FIG. 10, the method for expressing the signal levels which are shown by solid lines and broken lines is the same as in FIG. 5, and repeated description is omitted.

FIG. 11 shows an image of received data obtained by receiver 18 in the n-th frame shown in FIG. 10. In broken-line frame α, broken-line frame β in FIG. 11, the method for expressing the received data which is shown based on the size of a circle is the same as in FIG. 6, and repeated description is omitted.

Sensor controller 116 calculates two touch coordinates based on the received data shown in broken-line frame α in FIG. 11. The calculated touch coordinates are (x, y)=(Rx2Rx3, Tx1Tx2) and (x, y)=(Rx7, Tx5).

Also, sensor controller 116 calculates two ID-appended x coordinates (ID, x) based on the received data shown in broken-line frame β in FIG. 11. Specifically, an ID-appended x coordinate (ID, x)=(1, Rx2Rx3) is calculated based on the received data of a signal transmitted from output Tx6 and received at inputs Rx1 to Rx8 through mat electrode 20a (ID1), user A himself/herself, and receiver electrodes R1 to R8. In the same manner, an ID-appended x coordinate (ID, x)=(3, Rx7) is calculated based on the received data of a signal transmitted from output Tx8 and received at inputs Rx1 to Rx8 through mat electrode 20c (ID3), user B himself/herself, and receiver electrodes R1 to R8.

When the touch coordinates and the ID-appended x coordinate calculated above are combined with the x coordinate as a common term, ID-appended touch coordinates are calculated. As a result, the ID-appended touch coordinates corresponding to touch A will be (ID, x, y)=(1, Rx2Rx3, Tx1Tx2). The ID-appended touch coordinates corresponding to touch B will be (ID, x, y)=(3, Rx7, Tx5). Touch coordinates and the operation position of a user may thereby be linked.

Additionally, an ID-appended y coordinate is not calculated in the second exemplary embodiment because the sensor surface of the display is parallel to the gravity direction. It is assumed that, with such a display, users rarely perform operation with their arms intersecting each other, that is, a common x coordinate rarely occurs. However, also in the case where the sensor surface is made parallel to the gravity direction, the ID-appended y coordinate may be calculated as necessary, as in the first exemplary embodiment.

### <2-3. Effects, etc.>

As described above, according to the second exemplary embodiment, in addition to the touch coordinates of a user on the touch panel, the operation position of the user may be detected while using the configuration of the touch panel. That is, information about an operation of a user (touch coordinates and operation position) may be calculated by a simple configuration. Therefore, a plurality of touch operations may be distinguished from each other. As a result, user detection device 111 may be used to identify a user or to detect movement, for example. Moreover, in the second exemplary embodiment, a selector is not necessary, and calculation at sensor controller 116 is facilitated. Accordingly, a configuration which is simpler than that in the first exemplary embodiment may be realized.

### Third Exemplary Embodiment

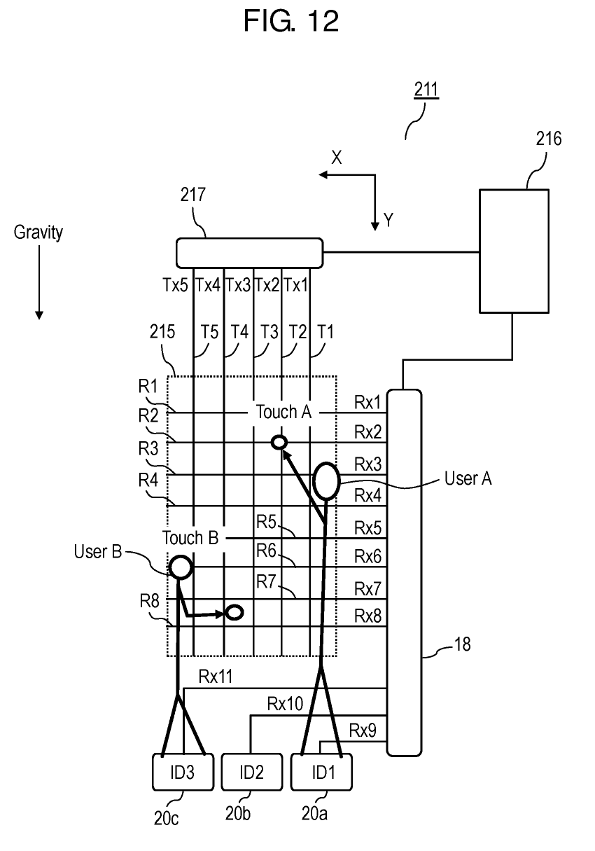

In the following, user detection device 211 according to a third exemplary embodiment will be described with reference to FIGS. 12 to 14. In the third exemplary embodiment, transmitter 217 and receiver 18 are disposed at positions opposite to the positions in the second exemplary embodiment.

### <3-1. Configuration>

FIG. 12 is a diagram showing a configuration of user detection device 211 according to the third exemplary embodiment, and a relationship between a position of a user and a touch operation.

As shown in FIG. 12, mat electrodes 20a to 20c are connected to receiver 18. Also, as in the first and the second exemplary embodiments, mat electrodes 20a to 20c are associated with pieces of identification information ID1 to ID3, respectively.

Each transmitter electrode T1 to T5 is disposed in parallel to a Y-axis direction in FIG. 12. Each receiver electrode R1 to R8 is disposed in parallel to an X-axis direction in FIG. 12.

### <3-2. Operation>

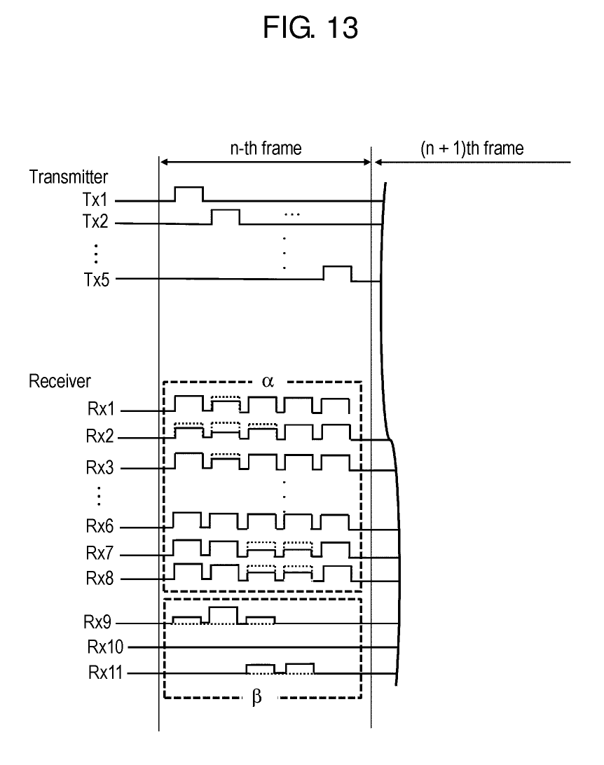

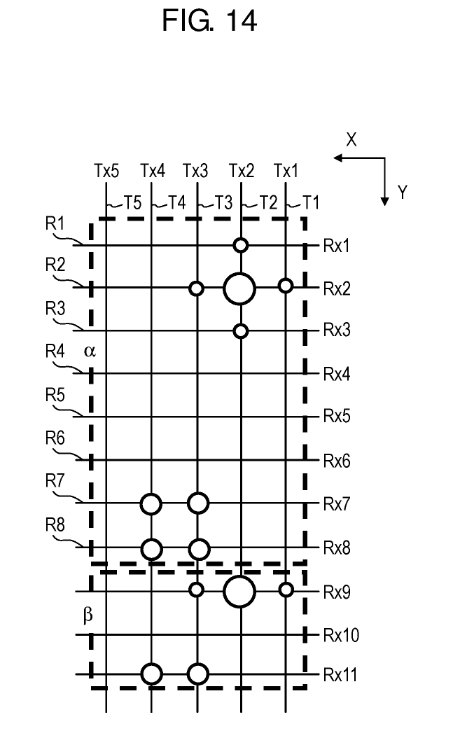

Operation of user detection device 211 of the third exemplary embodiment will be described with reference to FIGS. 12 to 14. FIG. 13 is an operation timing diagram of user detection device 211 according to the third exemplary embodiment. FIG. 14 is an image diagram of received data of user detection device 211 according to the third exemplary embodiment.

As shown in FIG. 12, user A is on mat electrode 20a (ID1). User A touches the position of touch A on sensor 215. The position of touch A in the X-axis direction is on transmitter electrode T2 connected to output Tx2. The position of touch A in the Y-axis direction is on receiver electrode R2 connected to input Rx2.

User B is on mat electrode 20c (ID3). User B touches the position of touch B on sensor 215. The position of touch B in the X-axis direction is in the middle of transmitter electrode T3 and transmitter electrode T4. The position of touch B in the Y-axis direction is in the middle of receiver electrode R7 and receiver electrode R8.

As shown in FIG. 13, outputs Tx1 to Tx5 sequentially output predetermined pulse signals, in order from output Tx1.

As shown in broken-line frame α in FIG. 13, received signals according to the pulse signals output from outputs Tx1 to Tx5 are input to inputs Rx1-Rx11.

As shown in broken-line frame β in FIG. 13, the predetermined pulse signals output from outputs Tx1 to Tx3 are detected at input Rx9 through transmitter electrodes T1 to T3, user A, and mat electrode 20a. Also, the predetermined pulse signals output from output Tx3 and output Tx4 are detected at input Rx11 through respective transmitter electrode T3 and transmitter electrode T4, user B, and mat electrode 20c.

The operations shown in broken-line frame α and broken-line frame β are in one frame, and the operations are repeated several times. An arbitrary frame shown in FIG. 13 is taken as an n-th frame. Additionally, in broken-line frame α, broken-line frame β in FIG. 13, the method for expressing the reception levels which are shown by solid lines and broken lines is the same as in FIG. 5, and repeated description is omitted.

FIG. 14 shows an image of received data obtained by receiver 18 in the n-th frame shown in FIG. 13. The method for expressing the image is the same as in FIGS. 6 and 11, and repeated description is omitted.

Sensor controller 216 calculates two touch coordinates based on the received data shown in broken-line frame α in FIG. 14. The calculated touch coordinates are (x, y)=(Tx2, Rx2) and (x, y)=(Tx3Tx4, Rx7Rx8).

Also, sensor controller 216 calculates two ID-appended x coordinates (ID, x) based on the received data shown in broken-line frame β in FIG. 14. Specifically, an ID-appended x coordinate (ID, x)=(1, Tx2) is calculated based on the received data of signals transmitted from outputs Tx1 to Tx5 and received at input Rx9 through transmitter electrodes T1 to T5, user A himself/herself, and mat electrode 20a (ID1). In the same manner, an ID-appended x coordinate (ID, x)=(3, Tx3Tx4) is calculated based on the received data of signals transmitted from outputs Tx1 to Tx5 and received at input Rx11 through transmitter electrodes T1 to T5, user B himself/herself, and mat electrode 20c (ID3). When the touch coordinates and the ID-appended x coordinate calculated above are combined with the x coordinate as a common term, ID-appended touch coordinates are calculated. As a result, the ID-appended touch coordinates corresponding to touch A will be (ID, x, y)=(1, Tx2, Rx2). The ID-appended touch coordinates corresponding to touch B will be (ID, x, y)=(3, Tx3Tx4, Rx7Rx8). Touch coordinates and the operation position of a user may thereby be linked.

Additionally, in the third exemplary embodiment, as in the second exemplary embodiment, an ID-appended y coordinate is not calculated.

### <3-3. Effects, etc.>

As described above, according to the third exemplary embodiment, in addition to the touch coordinates of a user on the touch panel, the operation position of the user may be detected while using the configuration of the touch panel. That is, information about an operation of a user (touch coordinates and operation position) may be calculated by a simple configuration. Therefore, a plurality of touch operations may be distinguished from each other. As a result, application for identification of a user or detection of movement is possible, for example. In addition, according to the third exemplary embodiment, the number of transmitter electrodes may be reduced compared to the first and the second exemplary embodiments. Accordingly, operation in one frame may be shortened, and the processing time of sensor controller 216 may be reduced.

### Fourth Exemplary Embodiment

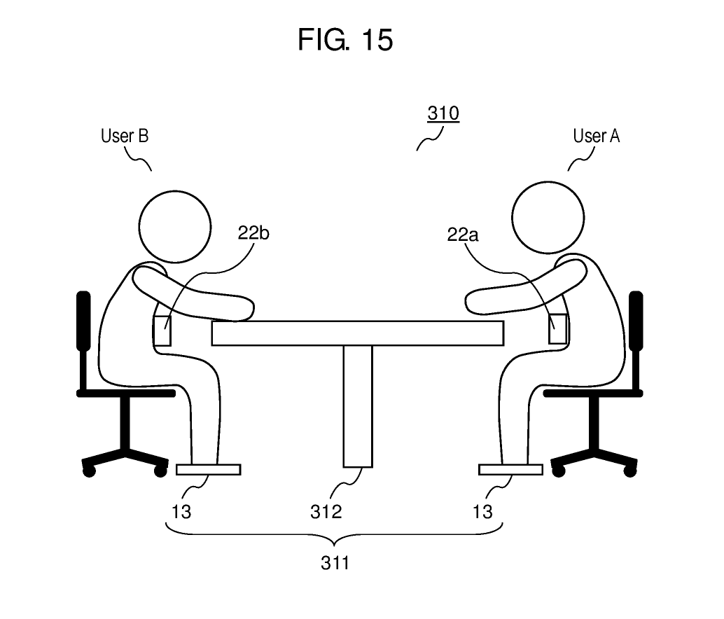

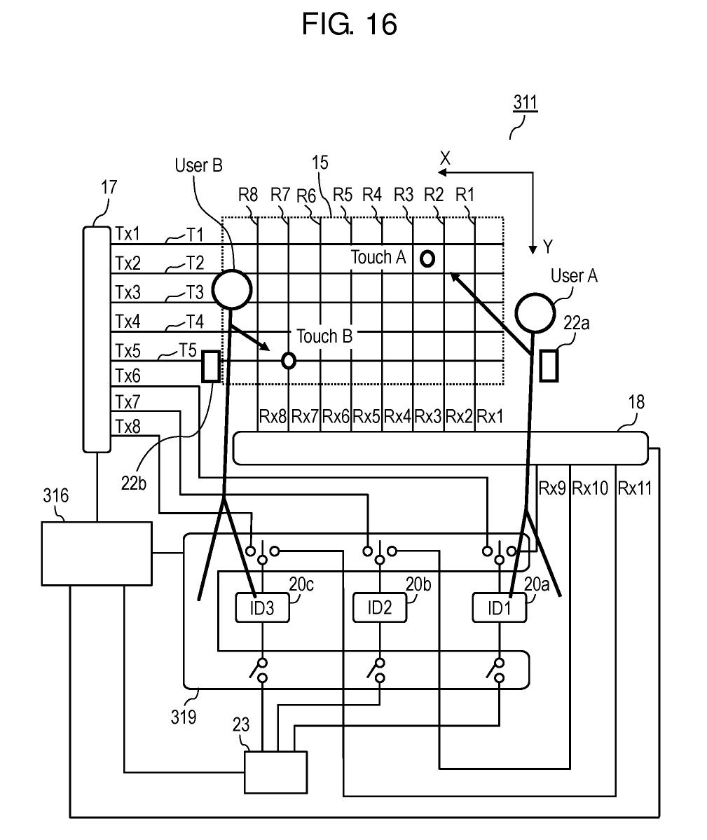

In the following, user detection device 311 of a fourth exemplary embodiment will be described with reference to FIGS. 15 and 16. User detection device 311 of the fourth exemplary embodiment is used in user detection system 310 shown in FIG. 15. User detection system 310 is user detection system 10 according to the first exemplary embodiment provided with a communication system that uses tag 22a and tag 22b. Using tag 22a and tag 22b is capable of specifying users, information about the users, and the like. Description regarding the same configuration, operation, effects and the like as the first exemplary embodiment will be omitted.

### <4-1. Configuration>

FIG. 15 is an external view of user detection system 310 according to the fourth exemplary embodiment. FIG. 16 is a diagram showing a configuration of user detection device 311 according to the fourth exemplary embodiment, and a relationship between a position of a user and a touch operation.

A system which is capable of communication through the body of a user by using an electric field is installed in table 312 shown in FIG. 15. Details of the system will be given later.

Moreover, user A carries tag 22a. User B carries tag 22b.

Each tag 22a, 22b holds information (tag information) for specifying a user. Tag 22a and tag 22b are capable of communication using an electric field. Additionally, tag 22a and tag 22b are card-shaped, for example. Tag 22a and tag 22b each have a battery mounted thereon.

As shown in FIG. 16, user detection device 311 of the fourth exemplary embodiment includes, in addition to the configuration of the first exemplary embodiment, tag 22a and tag 22b, described above, and electric field communication unit 23.

Electric field communication unit 23 communicates with tag 22a and tag 22b through mat electrodes 20a to 20c and bodies of user A and user B, by using a predetermined electric field.

Sensor controller 316 controls transmitter 17, receiver 18, selector 319, and electric field communication unit 23.

As in the first exemplary embodiment, selector 319 switches connection so as to connect mat electrodes 20a to 20c to one of transmitter 17 and receiver 18. In addition, selector 319 switches connection between electric field communication unit 23 and each of mat electrodes 20a to 20c.

### <4-2. Operation>

In the following, operation of user detection device 311 will be described.

First, before detection of touch operations of user A and user B, that is, at a timing before one operation frame as shown in FIG. 5, electric field communication is performed between each of tag 22a and tag 22b and electric field communication unit 23.

Specifically, sensor controller 316 controls selector 319, and electric field communication unit 23 and mat electrode 20a to 20c are connected.

Next, sensor controller 316 causes electric field communication unit 23 to start electric field communication. At this time, user A holding tag 22a is performing operation while being on mat electrode 20a. Accordingly, electric field communication unit 23 transmits an instruction to tag 22a through mat electrode 20a and user A. Also, user B holding tag 22b is performing operation while being on mat electrode 20c. Accordingly, electric field communication unit 23 transmits an instruction to tag 22b through mat electrode 20c and user B.

Then, in response to the instruction from electric field communication unit 23, tag 22a transmits tag information held by tag 22a to electric field communication unit 23 through user A and mat electrode 20a. For its part, in response to the instruction from electric field communication unit 23, tag 22b transmits tag information held by tag 22b to electric field communication unit 23 through user B and mat electrode 20c.

Additionally, electric field communication is performed for each of mat electrodes 20a to 20c. Accordingly, user detection device 311 performs electric field communication three times before one frame.

Sensor controller 316 uses pieces of tag information acquired by electric field communication unit 23, together with identification information ID1 to ID3 of each of mat electrodes 20a to 20c from which the pieces of tag information have been acquired. Specifically, sensor controller 316 combines the tag information with calculated ID-appended touch coordinates. Sensor controller 316 is thereby enabled to specify a user performing a touch operation, or to identify whether a user is a user holding tag 22a or tag 22b or other users. In this manner, by using tag 22a and tag 22b, it becomes possible to accept only the touch operation of a specific user, or to detect an operation of the specific user even if the user moves, for example.

Additionally, the tag information may be information about a user other than information for specifying a user.

Also, user detection device 311 of the fourth exemplary embodiment is user detection device 11 of the first exemplary embodiment to which tag 22a and tag 22b are added, but tag 22a and tag 22b may also be applied to user detection device 11 of the second exemplary embodiment or user detection device 211 of the third exemplary embodiment.

### <4-3. Effects, etc.>

As described above, according to the fourth exemplary embodiment, a user may be specified, or information about a user may be added, for example, by using tag 22a and tag 22b and mat electrodes 20a to 20c. Also, touch coordinates and a user position may be linked by using mat electrode 20a to 20c.

Additionally, in the fourth exemplary embodiment described above, a case is illustrated where a time period for electric communication between each tag 22a, tag 22b and electric field communication unit 23 is provided for each operation frame. However, for example, in a case where a touch operation is drawing, the time period for electric communication between each tag 22a, tag 22b and electric field communication unit 23 may simply be the time when a first touch operation is confirmed. That is, in the case where a touch operation continues after a first touch operation is confirmed (i.e. drawing), the operation may be judged as an operation by a same person having tag 22a, tag 22b. Accordingly, tag 22a and tag 22b do not have to perform electric field communication in every operation frame. Therefore, electric field communication may be performed between each tag 22a, tag 22b and electric field communication unit 23 only when a first touch is confirmed. In this manner, the time period in which each tag 22a, tag 22b and electric field communication unit 23 perform electric field communication may be arbitrarily set. Accordingly, power consumption of the batteries of tag 22a and tag 22b may be reduced.

Furthermore, in the fourth exemplary embodiment described above, it is indicated that the touch coordinates, tag 22a and tag 22b, and identification information ID1 to ID3 of mat electrode 20a to 20c are linked. Accordingly, if a user not holding either of tag 22a and tag 22b performs a touch operation, sensor controller 316 may ignore ID-appended xy coordinates corresponding to mat electrode 20a to 20c linked with neither tag 22a nor tag 22b. Therefore, only a user who has at least one of tag 22a and tag 22b may be allowed to perform a touch operation.

### Fifth Exemplary Embodiment

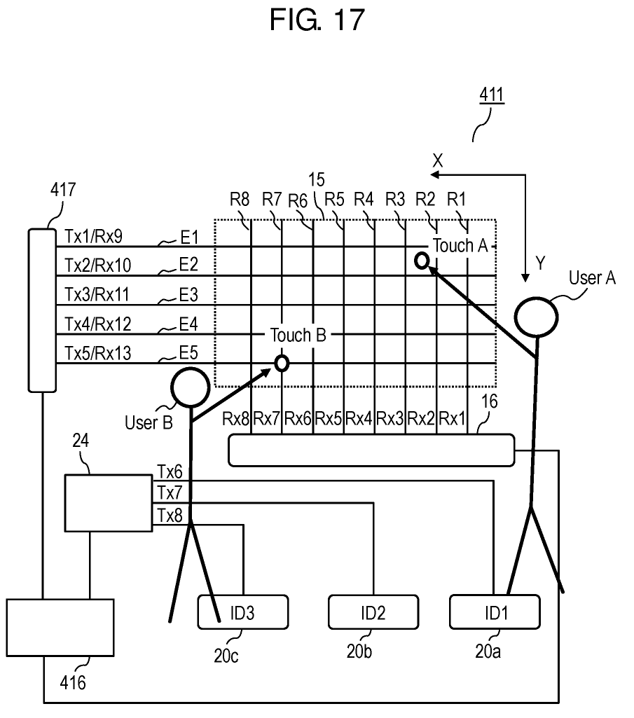

In the following, user detection device 411 of a fifth exemplary embodiment will be described with reference to FIGS. 17 to 19. User detection device 411 includes transmitter/receiver 417, instead of transmitter 17 of the first exemplary embodiment. Description regarding the same configuration, operation, effects and the like as the first exemplary embodiment to the fourth exemplary embodiment will be omitted.

### <5-1. Configuration>

FIG. 17 is an explanatory diagram showing a configuration of user detection device 411 according to the fifth exemplary embodiment, and a relationship between a position of a user and a touch operation. As shown in FIG. 17, user detection device 411 of the fifth exemplary embodiment includes transmitter/receiver 417. Also, in addition to the configuration of user detection device 11 of the first exemplary embodiment, user detection device 411 includes signal generator 24.

Transmitter/receiver 417 includes a transmission function for outputting a signal to sensor 15, and a reception function for receiving a signal from sensor 15. Specifically, transmitter/receiver 417 includes outputs Tx1 to Tx5 and inputs Rx9 to Rx13. The transmission function and the reception function of transmitter/receiver 417 are switched by sensor controller 416.

Outputs Tx1 to Tx5 (inputs Rx9 to Rx13) are connected to transmitter/receiver electrodes E1 to E5, respectively. When transmitter/receiver 417 is in a transmission state, transmitter/receiver electrodes E1 to E5 are made transmitter electrodes. When transmitter/receiver 417 is in a reception state, transmitter/receiver electrodes E1 to E5 are made receiver electrodes. Transmitter/receiver electrodes E1 to E5 are each in parallel to an X-axis of sensor 15.

Signal generator 24 supplies signals to mat electrodes 20a to 20c. Signal generator 24 is controlled by sensor controller 416.

### <5-2. Operation>

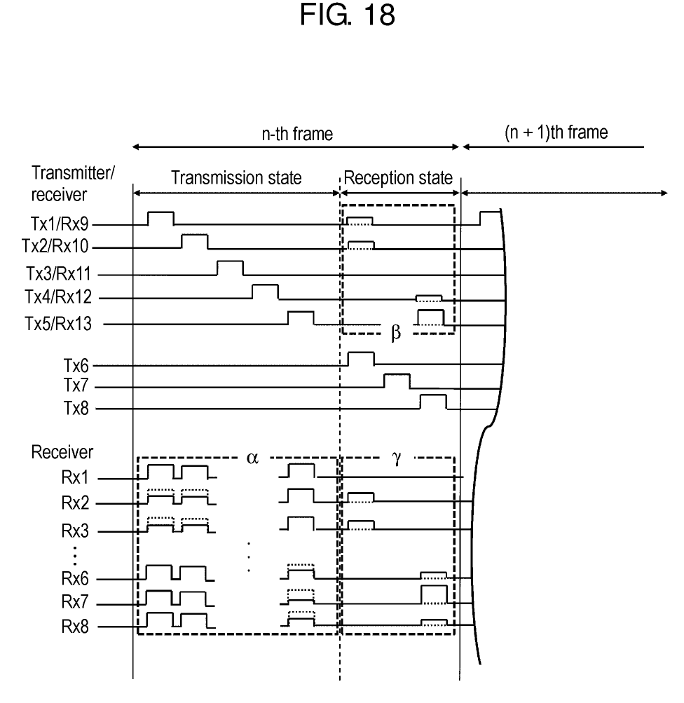

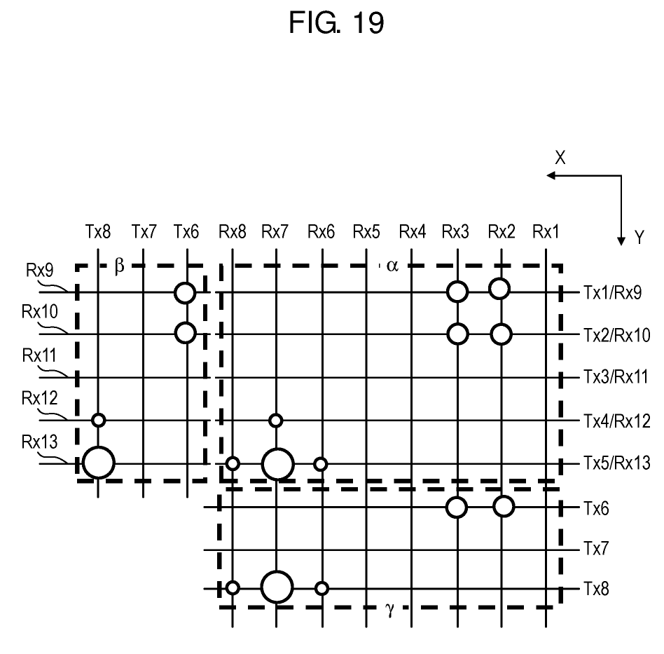

Operation of user detection device 411 will be described with reference to FIGS. 17 to 19. FIG. 18 is an operation timing diagram of user detection device 411 according to the fifth exemplary embodiment. FIG. 19 is an image diagram of received data of user detection device 411 according to the fifth exemplary embodiment.

As shown in FIG. 17, user A and user B are performing the same touch operations as user A and user B in the first exemplary embodiment.

As shown in FIG. 18, transmitter/receiver 417 switches between the transmission state and the reception state in one frame. That is, when in the transmission state, transmitter/receiver 417 uses terminals as outputs Tx1 to Tx5, and when in the reception state, transmitter/receiver 417 uses the terminals as inputs Rx9 to Rx13.

When transmitter/receiver 417 is in the transmission state, transmitter/receiver 417 sequentially outputs predetermined pulse signals from outputs Tx1 to Tx5.

As shown in broken-line frame α in FIG. 18, received signals according to the respective pulse signals output from outputs Tx1 to Tx5 are input to inputs Rx1 to Rx8.

Next, sensor controller 416 switches transmitter/receiver 417 from the transmission state to the reception state. Also, sensor controller 416 instructs signal generator 24 to output signals. In this manner, sensor controller 416 controls (synchronizes) timings of output of transmitter/receiver 417 and signal generator 24. In response to the instruction from sensor controller 416, signal generator 24 outputs predetermined pulse signals from outputs Tx6 to Tx8.

As shown in broken-line frame β in FIG. 18, the predetermined pulse signal output from output Tx6 is detected at input Rx9 and input Rx10 through mat electrode 20a, user A, transmitter/receiver electrode E1 and transmitter/receiver electrode E2. Also, the predetermined pulse signal output from output Tx8 is detected at input Rx12 and input Rx13 through mat electrode 20c, user B, transmitter/receiver electrode E4 and transmitter/receiver electrode E5.

Furthermore, as shown in broken-line frame γ in FIG. 18, the predetermined pulse signal output from output Tx6 is detected at input Rx2 and input Rx3 through mat electrode 20a, user A, receiver electrode R2 and receiver electrode R3. Moreover, the predetermined pulse signal output from output Tx8 is detected at inputs Rx6 to Rx8 through mat electrode 20c, user B, and receiver electrodes R6 to R8.

The operations shown in broken-line frame α, broken-line frame β, broken-line frame γ are in one frame, and the operations are repeated several times. An arbitrary frame shown in FIG. 18 is taken as an n-th frame. In broken-line frame α, broken-line frame β, broken-line frame γ in FIG. 18, the method for expressing the reception levels which are shown by solid lines and broken lines is the same as in FIG. 5, and repeated description is omitted.

FIG. 19 shows an image of received data obtained by receiver 18 in the n-th frame shown in FIG. 18.

Specifically, although the fifth exemplary embodiment is approximately the same as the first to the fourth exemplary embodiments described above, processing of received data in broken-line frame β is different. In broken-line frame β, ID1 to ID3 corresponding to each of mat electrodes 20a to 20c and the touch coordinate of each user in the Y-axis direction are calculated based on input Rx, not based on output Tx of transmitter/receiver 417. That is, sensor controller 416 calculates two ID-appended y coordinates (ID, y)=(1, Rx9Rx10) and (ID, y)=(3, Rx13) based on the received data shown in broken-line frame β in FIG. 19.

At this time, because Tx corresponding to the Rx of transmitter/receiver 417 is stored in sensor controller 416, sensor controller 416 transforms the Rx in the ID-appended y coordinate into Tx. That is, ID-appended y coordinates (ID, y)=(1, Tx1Tx2) and (ID, y)=(3, Tx5) are calculated.

Also, as in the first to the fourth exemplary embodiments, sensor controller 416 calculates ID-appended touch coordinates based on the data of the ID-appended y coordinate after transformation and the received data in broken-line frame γ. Specifically, (ID, x, y)=(1, Rx2Rx3, Tx1Tx2) and (ID, x, y)=(3, Rx7, Tx5) are calculated.

### <5-3. Effects, etc.>

As described above, according to the fifth exemplary embodiment, received data the same as the received data in the first exemplary embodiment may be acquired. That is, the received data may be processed in the same manner as in the first exemplary embodiment also by the configuration in which transmitter/receiver 417 functions as both transmitter 17 and receiver 18. Also, transmission and reception may be partially performed by using the same wires, and the configuration of sensor controller 416 may be simplified.

### Sixth Exemplary Embodiment

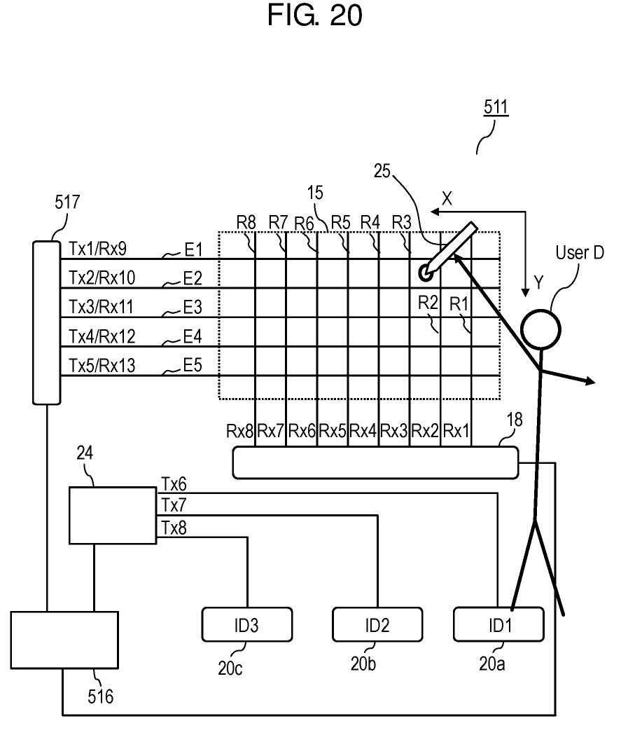

In the following, user detection device 511 of a sixth exemplary embodiment will be described with reference to FIGS. 20 to 23. With user detection device 511, a user performs a touch operation on a touch panel by using a touch pen.

### <6-1. Configuration>

In the following, configurations of user detection device 511 and touch pen 25 used for user detection device 511 will be described.

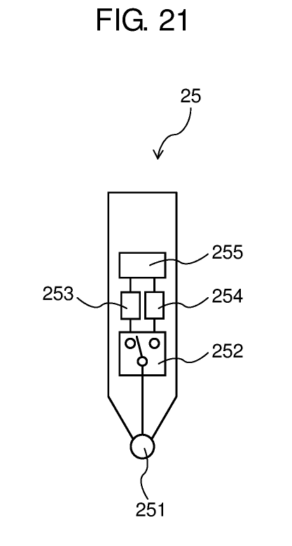

FIG. 20 is a diagram showing a configuration of user detection device 511 according to the sixth exemplary embodiment, and a relationship between a position of a user and a touch operation. FIG. 21 is a block diagram of touch pen 25 used in the sixth exemplary embodiment.

As shown in FIG. 20, the configuration of user detection device 511 is the same as that of user detection device 411 of the fifth exemplary embodiment. Transmitter/receiver 517 corresponds to transmitter/receiver 417 of the fifth exemplary embodiment, and sensor controller 516 corresponds to sensor controller 416 of the fifth exemplary embodiment. Additionally, transmitter/receiver 517 of user detection device 511 corresponds to a first transmitter, and signal generator 24 corresponds to a second transmitter.

In the sixth exemplary embodiment, user D is illustrated as a user. User D performs a touch operation by using touch pen 25.

As shown in FIG. 21, touch pen 25 includes pen tip 251, pen selector 252, synchronization signal receiver 253, pen signal generator 254, and pen controller 255. Such touch pen 25 is assigned with identification information ID different from those of mat electrodes 20a to 20c. For example, ID1 to ID3 are assigned to mat electrodes 20a to 20c, and ID4 is assigned to touch pen 25.

The material of the surface of a housing of touch pen 25 is a conductive material.

Pen tip 251 is a tip end portion of touch pen 25. The material of the surface of pen tip 251 is a conductive material. User D presses pen tip 251 against a sensor surface. Pen tip 251 is connected to synchronization signal receiver 253 and pen signal generator 254 through pen selector 252.

Pen selector 252 switches a connection target of pen tip 251 to one of synchronization signal receiver 253 and pen signal generator 254.

Synchronization signal receiver 253 receives a synchronization signal output from transmitter/receiver 517 of user detection device 511.

Pen signal generator 254 outputs a signal regarding identification information ID4.

Pen controller 255 controls the switching operation of pen selector 252.

### <6-2. Operation>

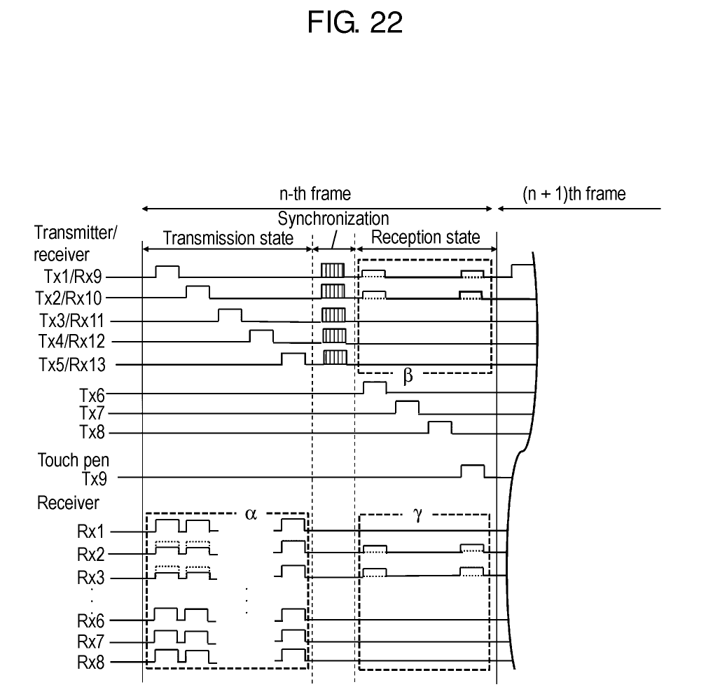

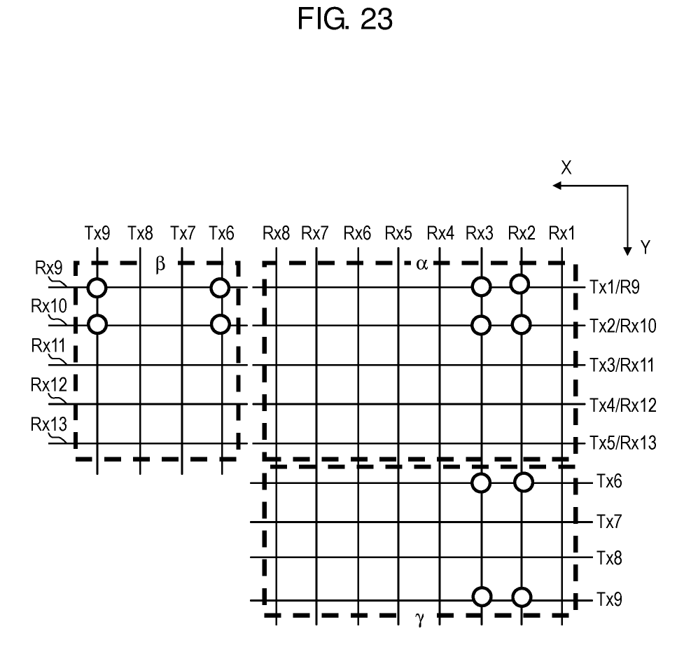

Operations of user detection device 511 and touch pen 25 configured in the manner described above will be described with reference to FIGS. 20, 22 and 23. FIG. 22 is an operation timing diagram of user detection device 511 and touch pen 25 according to the sixth exemplary embodiment. FIG. 23 is an image diagram of received data of user detection device 511 according to the sixth exemplary embodiment.

One of main differences between the sixth exemplary embodiment and the fifth exemplary embodiment is that a signal is output from output Tx9 of touch pen 25. Also, another of main differences is that there is a timing, in one frame of operation, at which a signal for synchronizing a signal which is transmitted from transmitter/receiver 517 and a signal which is output from touch pen 25 is transmitted.

As shown in FIG. 20, user D performs a touch operation on the sensor surface, at the position of touch A the same as user A in the fifth exemplary embodiment.

Furthermore, as shown in FIG. 22, predetermined pulse signals are sequentially output from outputs Tx1 to Tx5. At this time, pen controller 255 controls pen selector 252 so as to achieve a state in which pen tip 251 and synchronization signal receiver 253 are connected.

As shown in broken-line frame α in FIG. 22, received signals according to the respective pulse signals output from outputs Tx1 to Tx5 are input to inputs Rx1 to Rx8. Additionally, the material of the housing of touch pen 25 is a conductive material, and thus, the same received data as in the case of a touch operation by hand may be obtained also in the case of a touch operation by touch pen 25. That is, reception levels of signals output from output Tx1 and output Tx2 and detected by input Rx2 and input Rx3, respectively, through transmitter/receiver electrode E1 and transmitter/receiver electrode E2, and receiver electrode R2 and receiver electrode R3 are reduced by the touch operation by user D using touch pen 25.

Next, sensor controller 516 controls transmitter/receiver 517, and a synchronization signal is thereby output from transmitter/receiver 517.

Then, synchronization signal receiver 253 of touch pen 25 receives the synchronization signal output from transmitter/receiver 517. Touch pen 25 is thereby synchronized with transmitter/receiver 517 of user detection device 511.

Furthermore, pen controller 255 controls pen selector 252 based on information from synchronization signal receiver 253, and connects pen tip 251 and pen signal generator 254.

Also, when the synchronization signal is output, sensor controller 516 controls transmitter/receiver 517, and the transmitter/receiver 517 is thereby switched from the transmission state to the reception state.

Then, when sensor controller 516 controls signal generator 24, signal generator 24 outputs predetermined pulse signals from outputs Tx6 to Tx8.

Also, pen signal generator 254 transmits a predetermined pulse signal from output Tx9 based on the received synchronization signal.

As shown in broken-line frame β in FIG. 22, the predetermined pulse signal output from output Tx6 is detected at input Rx9 and input Rx10 through mat electrode 20a, user D, touch pen 25, transmitter/receiver electrode E1 and transmitter/receiver electrode E2. Also, the predetermined pulse signal output from Tx9 is detected at input Rx9 and input Rx10 through transmitter/receiver electrode E1 and transmitter/receiver electrode E2.

Furthermore, as shown in broken-line frame γ in FIG. 22, the predetermined pulse signal output from output Tx6 is detected at input Rx2 and input Rx3 through mat electrode 20a, user D, touch pen 25, and receiver electrode R2 and receiver electrode R3. Also, the predetermined pulse signal output from output Tx9 is detected at input Rx2 and input Rx3 through receiver electrode R2 and receiver electrode R3.

The operations shown in broken-line frame α, broken-line frame β, broken-line frame γ are in one frame, and the operations are repeated several times. An arbitrary frame shown in FIG. 22 is taken as an n-th frame. In broken-line frame α, broken-line frame β, broken-line frame γ in FIG. 22, the method for expressing the reception levels which are shown by solid lines and broken lines is the same as in FIG. 5, and repeated description is omitted.

FIG. 23 shows an image of received data obtained by receiver 18 in the n-th frame shown in FIG. 22.

Touch coordinates and ID-appended xy coordinates calculated based on the received data in FIG. 22 are the same as the touch coordinates and the ID-appended touch coordinates corresponding to the touch operation of user A in the fifth exemplary embodiment. The touch coordinates which are calculated are (x, y)=(Rx2Rx3, Tx1Tx2). Also, the ID-appended touch coordinates which are calculated are (ID, x, y)=(1, Rx2Rx3, Tx1Tx2).

Furthermore, an ID-appended x coordinate (4, Rx2Rx3) is calculated based on the received data in broken-line frame γ in FIG. 23. The x coordinate of the ID-appended x coordinate and the touch coordinates are made a common term, and ID-appended touch coordinates (4, Rx2Rx3, Tx1Tx2) are calculated.

### <6-3. Effects, etc.>

As described above, in the sixth exemplary embodiment, information about touch pen 25 may be acquired in addition to the received data in the fifth exemplary embodiment. That is, user detection device 511 that uses touch pen 25 may be realized simply by achieving synchronization with touch pen 25, while hardly changing the configuration of user detection device 411 of the fifth exemplary embodiment.

Additionally, in the sixth exemplary embodiment, pen signal generator 254 of touch pen 25 may be used as signal generator 24. Specifically, a holder for holding touch pen 25 is provided to the table, for example. It is assumed that pen tip 251 is capable of connecting to mat electrode 20a to 20c through the holder. According to this configuration, pen signal generator 254 of touch pen 25 may be used as signal generator 24.

That is, in a case where a number of touch pens 25 is plural, mat electrodes 20a to 20c may be used for specifying users by associating the plurality of touch pens and respective mat electrodes 20a to 20c.

Furthermore, insertion/removal of touch pen 25 with respect to the holder may be detected to switch between the functions of signal generator 24 and pen signal generator 254.

### Other Exemplary Embodiments

The exemplary embodiments described above are for illustrating the technology of the present disclosure, and various modifications, substitutions, additions, and omissions may be performed within the scope of claims and equivalents to the claims.

Accordingly, in the following, other exemplary embodiments will be illustrated.

In any of the first exemplary embodiment to the sixth exemplary embodiment, mat electrodes 20a to 20c are disposed on the floor at the feet. However, in a case where the display is disposed on a table, the functions of mat electrodes 20a to 20c may be provided to chairs. Also, detection electrodes corresponding to mat electrodes 20a to 20c may be disposed on the table. That is, it is sufficient that the detection electrodes are disposed at positions that allows the detection electrodes to contact with users.

In the first exemplary embodiment to the sixth exemplary embodiment, electrodes in the shape of a square lattice are used as sensor 15, but another shape such as a rectangle or a rhombus may also be used as long as coordinates may be detected.

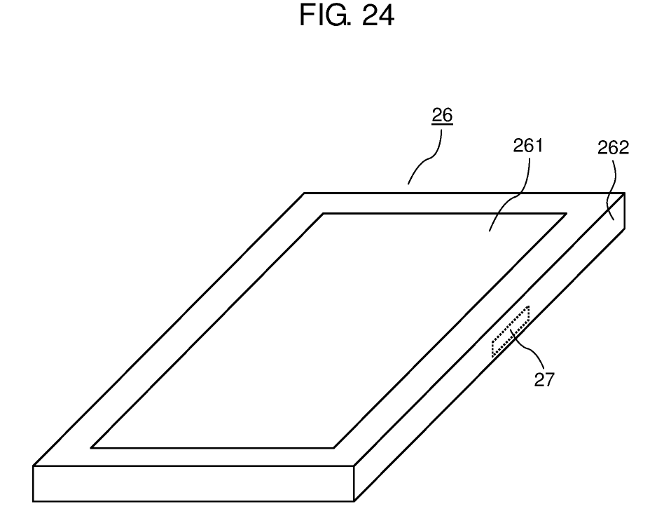

Also, in the first exemplary embodiment to the sixth exemplary embodiment, user detection devices that can be used by a plurality of users are described as examples, but mobile terminal 26 as shown in FIG. 24 may also be used. In this case, as shown in FIG. 24, detection electrode 27 corresponding to mat electrodes 20a to 20c may be provided at a part different from display surface 261 of mobile terminal 26, such as on side surface 262. By using the user detection device, a case where a touch operation is performed on display surface 261 by touching detection electrode 27 and a case where a touch operation is performed without touching detection electrode 27 may be distinguished from each other. Detection electrode 27 only needs to be conducted with a user, and may be exposed from or be embedded in the mobile terminal.

The user detection device as shown in FIG. 24 may be applied to a drawing application, for example. In this case, switching of commands, such as in the case of a complex operation of “draw, erase, then redraw”, may be performed based on whether detection electrode 27 is being touched or not. That is, commands may be assigned to detection electrode 27. As a result, the operability of the application may be greatly increased.

Moreover, the user detection device may be applied to a mobile terminal that uses a touch pen. A touch operation by a touch pen and a touch operation by the hand of a user may be distinguished from each other by using the user detection device. In this case, a detection electrode corresponding to mat electrodes 20a to 20c is provided on an outer circumference of the mobile terminal. Identification information ID is assigned to the detection electrode. A user is to constantly touch the detection electrode. Also, the material of the housing of the touch pen is an insulating material, and the material of the pen tip is conductive. According to this configuration, a touch operation by the pen tip is not affected by the detection electrode provided to the mobile terminal.

That is, when a user touches the mobile terminal with hand, the touch is detected by the detection electrode of the mobile terminal, and a signal which is assigned with the ID of the detection electrode is calculated. On the other hand, in the case where touch is performed with the pen tip, the touch is not detected by the detection electrode of the mobile terminal, and a signal which is assigned with the ID of the detection electrode is not detected. Accordingly, an operation by the pen tip and a touch operation by hand may be distinguished from each other. Therefore, for example, if a touch is erroneously performed by a part other than the pen tip, the touch may be processed as an erroneous operation. In the case of such a touch pen, a power source and circuit components do not have to be mounted, unlike touch pen 25 described in the sixth exemplary embodiment. Accordingly, an inexpensive and strong touch pen may be structured. However, it is desirable that the material of the pen tip is a conductive material, and a predetermined capacitance is present between the pen tip and the hand of a user holding the pen.

Furthermore, in the first exemplary embodiment to the sixth exemplary embodiment, the mat electrodes are used to assign IDs to touch coordinates, but the mat electrodes may alternatively be used to assign commands as described above.

Moreover, in the first exemplary embodiment to the sixth exemplary embodiment, cases have been described where users are present on the mat electrodes. In the case where no user is present, output of the mat electrode is not detected, and absence of a user may be identified.

The present disclosure may be applied to a touch panel and the like, and may be used in various fields such as education, games and the like.

What is claimed is:

1. A detection device comprising:
a plurality of transmitter electrodes that are provided in a predetermined area;
a plurality of receiver electrodes that are provided in the predetermined area and that each intersect with the plurality of transmitter electrodes;
a transmitter that is connected to the plurality of transmitter electrodes;
a receiver that is connected to the plurality of receiver electrodes;
a detection electrode that is provided outside the predetermined area and that is connected to at least one of the transmitter and the receiver; and
an operation detector configured to detect an operation of a user based on a reception result of the receiver.

2. The detection device according to claim 1, comprising a first signal path extending from the transmitter to the receiver through the plurality of transmitter electrodes and the plurality of receiver electrodes.

3. The detection device according to claim 2, wherein
the detection electrode is connected to the receiver, and
the detection device includes a second signal path extending from the transmitter to the receiver through at least one of the plurality of transmitter electrodes, the user, and the detection electrode.

4. The detection device according to claim 2, wherein
the detection electrode is connected to the transmitter, and
the detection device includes a third signal path extending from the transmitter to the receiver through the detection electrode, the user, and at least one of the plurality of receiver electrodes.

5. The detection device according to claim 1, wherein the detection electrode is disposed at a position that allows the detection electrode to contact with the user.

6. The detection device according to claim 5, wherein the detection electrode is disposed on a floor.

7. The detection device according to claim 1, wherein
the detection electrode is connected to the transmitter, and
the transmitter enable to output a plurality of signals that can be distinguished from each other, and to transmit the plurality of signals singly to each of the plurality of transmitter electrodes and the detection electrode.

8. The detection device according to claim 7, wherein the transmitter enable to output the plurality of signals at different timings from each other.

9. The detection device according to claim 1, comprising ground having capacitance between the ground and the detection electrode.

10. The detection device according to claim 1, comprising:
a tag that allows the user to carry; and
an electric field communication unit capable of communicating with the tag through the detection electrode and the user, by using an electric field.

11. The detection device according to claim 1, wherein
the transmitter includes a first transmitter that outputs a signal to the plurality of transmitter electrodes, and a second transmitter that outputs a signal to the detection electrode, and
the first transmitter and the second transmitter are synchronized with each other.
